(19) United States
(12) Patent Application Publication
(10) Pub. No.: US 2008/0286485 A1
(43) Pub. Date: Nov. 20, 2008

(54) Orientated Acrylate Adhesive Materials, Method for the Production and Use Thereof

(75) Inventors: Stephan Zollner, Buchholz/Nordheide (DE); Marc Husemann, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: TESA AG, HAMBURG (DE)

(21) Appl. No.: 10/586,432

(22) PCT Filed: Jan. 4, 2005
(86) PCT No.: PCT/EP2005/050021

§ 371 Date: Aug. 5, 2008

(30) Foreign Application Priority Data
Jan. 16, 2004 (DE) 10 2004 002 279.8

(51) Int. Cl. C08J 7/04; C08L 33/08; C08L 33/24; C08L 39/00; C08L 33/18

(52) U.S. Cl. 427/516; 522/153; 522/152; 522/151; 522/154; 522/120; 522/126; 522/129; 522/79

(57) ABSTRACT

The invention relates to an oriented pressure-sensitive adhesive and to a process for preparing it.

The pressure-sensitive adhesive comprises an acrylate-based UV-crosslinked polymer which is synthesized in a mass fraction of at least 50% from at least one acrylic monomer according to the general formula (I)

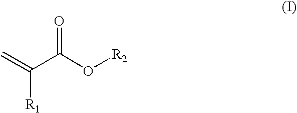

in which R₁ is hydrogen (H) or a methyl group (CH₃) and R₂ is hydrogen (H) or a branched or unbranched, saturated C₁ to C₃₀ hydrocarbon radical, which may optionally be substituted by a functional group, the pressure-sensitive adhesive, in the form of a film applied as a melt (hotmelt), having a preferential direction which is characterized in the free film by a shrinkback of at least 3% relative to an original stretching of the film in the preferential direction. The orientation is generated after polymerization by means of a suitable coating process and is subsequently “frozen in” by UV crosslinking. The pressure-sensitive adhesive is outstandingly suitable for use as an adhesive layer on single-sided or double-sided adhesive tapes.

The invention relates to oriented polyacrylate pressure-sensitive adhesives (PSAs), to their preparation and to their use for adhesive tapes.

As a result of ever-increasing environmental structures and cost pressure there is at present a trend towards preparing PSAs with little if any solvent. This objective can most easily be realized by means of the hotmelt technology. A further advantage of this technology is the acceleration of production and the concomitant cost reduction, since hotmelt lines can laminate adhesives much more quickly to carriers or release paper. The hotmelt technology, however, imposes increasingly exacting requirements on the adhesives. For high-grade industrial applications particular preference is given to polyacrylates, on account of their transparency and weathering stability. In order to prepare acrylate hotmelts, conventionally, acrylate monomers are polymerized in solution and the solvent is then removed in an extruder in a concentration operation. Besides the advantages of transparency and weathering stability, however, acrylate PSAs are also required to meet stringent requirements in terms of shear strength. This requirement is met by polyacrylates of high molecular weight and high polarity with subsequent efficient crosslinking.

One of the factors which plays a significant part as far as the properties of PSAs are concerned is the orientation of the macromolecules. During the preparation, further processing or subsequent (mechanical) stressing of polymers or polymer compositions there may be high degrees of orientation of the macromolecules in preferential directions within the polymer assembly as a whole. The orientation can lead to particular properties in the corresponding polymers. Some examples of properties which can be influenced by the degree of orientation include the strength and stiffness of the polymers and of the plastics produced from them, thermal conductivity, thermal stability and also anisotropy in respect of permeability to gases and liquids. In addition, however, oriented polymers may exhibit anisotropic stress/strain characteristics. One important property dependent on the orientation of the monomer units is the refraction of light (expressed by way of the corresponding refractive index n and/or the retardation δ). Measuring the refraction of light is therefore used as a method of determining the orientation of polymers, particularly in PSAs. Another method of determining the orientation is to measure the shrinkback in the free film.

Retention of the partial orientation in conventional partially crystalline natural rubber PSAs is described in U.S. Pat. No. 5,866,249. The anisotropic adhesive properties allowed innovative PSA applications to be defined. In DE 100 34 069, in contrast, an operation is described for preparing oriented acrylate PSAs by means of electron irradiation (EB irradiation). DE 100 52 955, moreover, describes the use of such oriented acrylate PSAs prepared by the process according to DE 100 34 069.

Electron-beam crosslinking affords advantages from the process technology standpoint. Thus, for example, certain states can be “frozen in” by means of the crosslinking. Electron irradiation is not without its disadvantages, though. For instance, the electron beams penetrate not only the acrylate PSA but also the backing material and so lead to damage to the PSA tape. Generally speaking, the quality of crosslinking is likewise limited as compared with other crosslinking mechanisms, since as a result of the high energy some decomposition of the polymer is also observed. Furthermore, the cost and complexity of apparatus for EB irradiation are very high.

There is therefore a need for a process for preparing oriented PSAs by another crosslinking method which is and which prevents polymer degradation.

It is therefore an object of the invention to provide an oriented acylate PSA which does not have the abovementioned drawbacks of the prior art. In particular the acylate PSA ought to be preparable by a process which can be carried out without great cost or complexity of apparatus, and the unwanted polymer degradation of PSA and/or backing material ought to be avoided.

This object is achieved, surprisingly and in a manner unforeseeable for the skilled person, by means of a pressure-sensitive adhesive as described in the main claim and by its preparation according to claim 15.

The main claim accordingly provides a permanently oriented pressure-sensitive adhesive which is obtainable by free-radical addition polymerization, comprising an acrylate-based UV-crosslinked polymer which 1.) is synthesized in a mass fraction of at least 50% from at least one acrylic monomer according to the general formula (I)

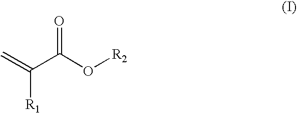

in which R₁ is hydrogen (H) or a methyl group (CH₃) and R₂ is hydrogen (H) or a branched or unbranched, saturated C₁ to C₃₀ hydrocarbon radical, which may optionally be substituted by one or more functional groups, and 2.) is composed in a mass fraction of from 0.05% and 1% of a UV-crosslinked photoinitiator, which may have been crosslinked according to Norrish type I or type II, the pressure-sensitive adhesive, in the form of a film applied as a melt (hotmelt), having a preferential direction which is characterized in the free film by a shrinkback of at least 3% relative to an original stretching of the film in the preferential direction.

In a further very preferred version the PSA has a refractive index measured in the preferential direction, n_{MD}, which is greater than a refractive index measured in a direction perpendicular to the preferential direction, n_{CD}, the difference Δn=n_{MD}−n_{CD} being at least 1·10⁻⁶. This orientation-based anisotropy may be measured in a simple way in accordance with Test B.

The orientation of the PSA is maintained permanently: the term “permanent” means a period of at least 30 days, in particular at least 3 months, preferably at least 1 year, within which an original shrinkback of the material is reduced to not more than 20%, in particular not more than 10%, advantageously based on the initial value.

The desired material properties are favoured by an average polymer molecular mass which ought to be at least 200 000 g/mol.

The monomers used for the polymerization are chosen such that the resulting polymers can be used as PSAs at room temperature or higher temperatures, particularly such that the resulting polymers possess PSA properties in accordance with the “Handbook of Pressure Sensitive Adhesive Technology” by Donatas Satas (van Nostrand, N.Y., 1989). In order to obtain a preferred polymer glass transition temperature T_{G}, viz T_{G}≦10° C., in accordance with the remarks above, the monomers are very preferably selected in such a way, and the quantitative composition of the monomer mixture advantageously chosen in such a way, that the desired T_{G} for the polymer is obtained in accordance with the Fox equation (E1) (cf. T. G. Fox, Bull. Am. Phys. Soc. 1 (1956) 123).

$$\frac{1}{{T}_{g}} = {\sum }_{n} \frac{{w}_{n}}{{T}_{g , n}} \qquad ( E 1 )$$

In this equation n represents the serial number of the monomers used, wₙ denotes the mass fraction of the respective monomer n (in % by weight) and T_{g,n} denotes the respective glass transition temperature of the homopolymer of the respective monomer n in K.

It is contemplated with particular preference that for the at least one acrylic monomer a compound according to the general formula I is chosen in which the radical R₁ is hydrogen (H) or CH₃ and the radical R₂ is hydrogen (H) or a radical selected from the group of branched or unbranched, saturated C₄ to C₁₄ hydrocarbon radicals, especially C₄ to C₉ hydrocarbon radicals, and R₂ can be substituted by one or more polar and/or functional groups.

In one very preferred version the monomers used include acrylic or methacrylic esters specific non-limiting examples are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and also the branched isomers of these, examples being isobutyl acrylate, 2-ethylhexyl acrylate, 2-ethylhexyl methacrylate, isooctyl acrylate and isooctyl methacrylate.

Further classes of compound which can be employed include monofunctional acrylates and/or methacrylates of formula (I) in which R₂ comprises a bridged or unbridged, substituted or unsubstituted cycloalkyl group composed of at least 6 carbon atoms. Examples of suitable substituents include C₁ to C₆ alkyl radicals and halide or cyanide groups. Specific examples of such monomers are cyclohexyl methacrylate, isobornyl acrylate, isobornyl methacrylate and 3,5-dimethyladamantyl acrylate.

In a further version monomers are used which carry functional and/or polar groups such as carboxyl, sulphonic acid, phosphonic acid, hydroxyl, lactam and lactone, N-substituted amide, N substituted amino, carbamate, epoxy, thiol, ether, alkoxy and cyano groups or the like.

According to a further advantageous embodiment of the invention the at least one acrylic monomer of formula (I) is polymerized with at least one further comonomer which may likewise carry one or more of the aforementioned functional and/or polar groups.

Moderate basic comonomers are, for example, N,N-dialkyl-substituted amides. Examples in this respect include in particular N,N-dimethylacrylamide, N,N-dimethylmethacrylamide, N-tert-butylacrylamide, N-vinylpyrrolidone, N-vinyllactam, dimethylaminoethyl acrylate, dimethylaminoethyl methacrylate, diethylaminoethyl acrylate, diethylaminoethyl methacrylate, N-methylolacrylamide, N-methylol-methacrylamide, N-(butoxymethyl)methacrylamide, N-(ethoxymethyl)acrylamide and N-isopropylacrylamide.

Further preferred examples are hydroxyethyl acrylate, hydroxyethyl methacrylate, hydroxypropyl acrylate, hydroxypropyl methacrylate, allyl alcohol, maleic anhydride, itaconic anhydride, itaconic acid, glycidyl methacrylate, phenoxyethyl acrylate, phenoxyethyl methacrylate, 2-butoxyethyl acrylate, 2-butoxyethyl methacrylate, cyanoethyl acrylate, cyanoethyl methacrylate, glyceryl methacrylate, 6-hydroxyhexyl methacrylate, vinylacetic acid, tetrahydrofurfuryl acrylate, O-acryloyloxypropionic acid, trichloroacrylic acid, fumaric acid, crotonic acid, aconitic acid, and dimethylacrylic acid, this enumeration not being conclusive.

In a further very preferred version comonomers used include vinyl esters, vinyl ethers, vinyl halides, vinylidene halides and vinyl compounds with aromatic rings and heterocycles in α position. Here as well mention may be made non-exclusively of certain examples: vinyl acetate, vinylformamide, vinylpyridine, ethyl vinyl ether, vinyl chloride, vinylidene chloride and acrylonitrile.

In a further preferred version comonomers possessing a high static glass transition temperature are added to the monomers described. Suitable components include aromatic vinyl compounds, such as styrene, in which case the aromatic nuclei can be composed preferably of C₄ to C₁₈ and may also contain heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate, 4-biphenylyl methacrylate, 2-naphthyl acrylate, 2-naphthyl methacrylate and also mixtures of these monomers, this enumeration not being conclusive.

The oriented pressure-sensitive adhesive according to the present invention can be prepared by a process which comprises the following steps:
(a) polymerizing at least one acrylic monomer according to the general formula (I),

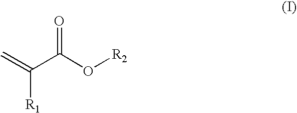

in which R₁ is hydrogen (H) or a methyl group (CH₃) and R₂ is hydrogen (H) or a branched or unbranched, saturated C₁ to C₃₀ hydrocarbon radical which is optionally substituted by a functional group,
(b) coating the acrylic polymer from the melt to form a film, in the course of which an orientation comes about in the pressure-sensitive adhesive, and
(c) crosslinking the film by means of UV radiation.

In this context it is possible to use all of the monomers described above, to which further comonomers, likewise mentioned above, may be added where appropriate. Preferably the polymerization takes place in the presence of one of the abovementioned crosslinkers.

The poly(meth)acrylate PSAs are advantageously prepared by conducting conventional free-radical addition polymerizations. For the polymerizations which proceed in accordance with a free-radical mechanism it is preferred to use initiator systems which additionally contain further free-radical initiators for the polymerization, particularly thermally decomposing, free-radical-forming azo or peroxo initiators. In principle, however, all of the customary initiators familiar to the skilled person for acrylates are suitable. The production of C-centred radicals is described in Houben Weyl, Methoden der Organischen Chemie, Vol. E 19a, pp. 60-147. These methods are preferentially employed analogously.

Examples of free-radical sources are peroxides, hydroperoxides and azo compounds; a number of non-exclusive examples of typical free-radical initiators that may be mentioned here include potassium peroxodisulphate, dibenzoyl peroxide, cumene hydroperoxide, cyclohexanone peroxide, di-t-butyl peroxide, azodiisobutyronitrile, cyclohexylsulphonyl acetyl peroxide, diisopropyl percarbonate, t-butyl peroctoate and benzpinacol. In one very preferred version the free-radical initiator used is 1,1′-azobis-(cyclohexanecarbonitrile) (Vazo 88™ from DuPont) or azodiisobutyronitrile (AIBN).

Moreover, in a further very preferred version, photoinitiators containing a copolymerizable double bond are used. Suitable photoinitiators include Norrish I and II photoinitiators. Examples are benzoin acrylate and an acrylated benzophenone from UCB (Ebecryl P 36®). This enumeration is not complete. In principle it is possible to use any photoinitiators known to the skilled person that are able to crosslink the polymer by way of a free-radical mechanism under UV irradiation. An overview of possible photoinitiators which can be used and which may be functionalized with a double bond is given Fouassier: “Photoinitiation, Photopolymerization and Photocuring: Fundamentals and Applications”, Hanser-Verlag, Munich 1995. For further details reference may be made to Carroy et al. in “Chemistry and Technology of UV and EB Formulation for Coatings, Inks and Paints”, Oldring (Ed.), 1994, SITA, London.

The average molecular weights M_{w} of the PSAs formed in the course of the free-radical polymerization are very preferably chosen such that they are situated within a range from 200 000 to 4 000 000 g/mol; specifically for further use as hotmelt PSAs, PSAs having average molecular weights M_{w} of from 600 000 to 800 000 g/mol are prepared. The average molecular weight is determined by size exclusion chromatography (GPC) or matrix-assisted laser desorption/ionization mass spectrometry (MALDI-MS).

The polymerization may be carried out in bulk, in the presence of one or more organic solvents, in the presence of water, or in mixtures of organic solvents and water. The aim is to minimize the amount of solvent used. Suitable organic solvents are pure alkanes (e.g., hexane, heptane, octane, isooctane), aromatic hydrocarbons (e.g., benzene, toluene, xylene), esters (e.g., ethyl, propyl, butyl or hexyl acetate), halogenated hydrocarbons (e.g., chlorobenzene), alkanols (e.g., methanol, ethanol, ethylene glycol, ethylene glycol monomethyl ether), and ethers (e.g., diethyl ether, dibutyl ether) or mixtures thereof. A water-miscible or hydrophilic cosolvent may be added to the aqueous polymerization reactions in order to ensure that in the course of monomer conversion the reaction mixture is in the form of a homogeneous phase. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulphides, sulphoxides, sulphones, alcohol derivatives, hydroxy ether derivatives, amino alcohols, ketones, and the like, and also derivatives and mixtures thereof.

The polymerization time is between 4 and 72 hours, depending on conversion and temperature. The higher the reaction temperature can be chosen, i.e., the higher the thermal stability of the reaction mixture, the lower the reaction time that can be chosen.

For the initiators which undergo thermal decomposition, the introduction of heat is essential to initiate the polymerization. For the thermally decomposing initiators the polymerization can be initiated by heating at from 50 to 160° C., depending on initiator type.

Another advantageous preparation process for the polyacrylate PSAs is anionic polymerization. In this case it is preferred to use inert solvents as the reaction medium, such as aliphatic and cycloaliphatic hydrocarbons, for example, or else aromatic hydrocarbons.

In this case the living polymer is generally represented by the structure P_{L}(A)-Me, in which Me is a metal from group I, such as lithium, sodium or potassium, and P_{L}(A) is a growing polymer block of the monomers A. The molar mass of the polymer to be prepared is controlled by the ratio of initiator concentration to monomer concentration. Examples of suitable polymerization initiators include n-propyllithium, n-butyllithium, sec-butyllithium, 2-naphthyllithium, cyclohexyllithium, and octyllithium, with this list making no claim to completeness. Furthermore, initiators based on samarium complexes are known for the polymerization of acrylates (Macromolecules, 1995, 28, 7886) and can be used here.

Moreover, it is also possible to use difunctional initiators, such as 1,1,4,4-tetraphenyl-1,4-dilithiobutane or 1,1,4,4-tetraphenyl-1,4-dilithioisobutane. Coinitiators may likewise be used. Suitable coinitiators include lithium halides, alkali metal alkoxides or alkylaluminium compounds. In one very preferred version the ligands and coinitiators are chosen such that acrylate monomers, such as n-butyl acrylate and 2-ethylhexyl acrylate, for example, can be polymerized directly and need not be generated in the polymer by a transesterification with the corresponding alcohol.

In order to prepare polyacrylate PSAs having a narrow molecular weight distribution, controlled radical polymerization methods are also suitable. For the polymerization it is then preferred to use a control reagent of the general formula:

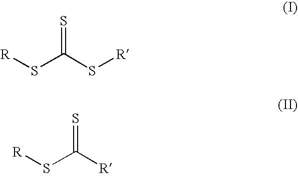

in which R and R¹ are chosen independently of one another or identical and are chosen from the group that embraces the following radicals:
branched and unbranched C₁ to C₁₈ alkyl radicals; C₃ to C₁₈ alkenyl radicals; C₃ to C₁₈ alkynyl radicals;
C₁ to C₁₈ alkoxy radicals;
C₃ to C₁₈ alkynyl radicals; C₃ to C₁₈ alkenyl radicals; C₁ to C₁₈ alkyl radicals substituted by at least one OH group or a halogen atom or a silyl ether;
C₂ to C₁₈ heteroalkyl radicals having at least one oxygen atom and/or one NR* group in the carbon chain, R* representing any (especially organic) radical;
C₃ to C₁₈ alkynyl radicals, C₃ to C₁₈ alkenyl radicals, C₁ to C₁₈ alkyl radicals substituted by at least one ester group, amine group, carbonate group, cyano group, isocyanato group and/or epoxide group and/or by sulphur;
C₃ to C₁₂ cycloalkyl radicals;
C₆ to C₁₈ aryl or benzyl radicals; and
hydrogen.

Control reagents of type (I) are composed preferably of the following further-restricted compounds, with the list below serving only as examples of the respective groups of compounds and making no claim to completeness:
Halogen atoms therein are preferably F, Cl, Br or I, more preferably Cl and Br. As alkyl, alkenyl, and alkynyl radicals in the various substituents, both linear and branched chains are outstandingly suitable.
Examples of alkyl radicals containing from 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl.
Examples of alkenyl radicals having from 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.
Examples of alkynyl having from 3 to 18 carbon atoms are propynyl, 2-butynyl, 3-butynyl, n-2-octynyl, and n-2-octadecynyl.
Examples of hydroxy-substituted alkyl radicals are hydroxypropyl, hydroxybutyl, and hydroxyhexyl.
Examples of halogen-substituted alkyl radicals are dichlorobutyl, monobromobutyl, and trichlorohexyl.
A suitable C₂-C₁₈ heteroalkyl radical having at least one oxygen atom in the carbon chain is, for example, —CH₂—CH₂—O—CH₂—CH₃.
Examples of C₃-C₁₂ cycloalkyl radicals include cyclopropyl, cyclopentyl, cyclohexyl, and trimethylcyclohexyl.
Examples of C₆-C₁₈ aryl radicals include phenyl, naphthyl, benzyl, 4-tert-butylbenzyl or further substituted phenyl, such as ethyl, toluene, xylene, mesitylene, isopropylbenzene, dichlorobenzene or bromotoluene.

Moreover, compounds of the following types may also be used as control reagents

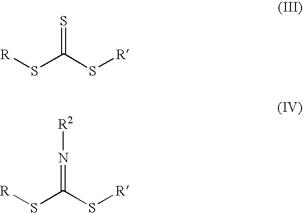

where R² likewise may be chosen independently of R and R¹ from the above-recited group for these radicals.

In the case of the conventional “RAFT” process, polymerization is normally carried out only to low conversions (WO 98/01478 A1) in order to obtain very narrow molecular weight distributions. As a result of the low conversions, however, these polymers cannot be used as PSAs and in particular not as hotmelt PSAs, since the high fraction of residual monomers adversely affects the technical adhesive properties; the residual monomers would contaminate the solvent recyclate in the concentration operation and the corresponding self-adhesive tapes would exhibit very high outgassing behaviour. In order to circumvent this drawback of low conversions, in one particularly preferred procedure the polymerization is initiated a number of times.

As a further controlled radical polymerization method it is possible to carry out nitroxide-controlled polymerizations. In an advantageous procedure, radical stabilization is effected using nitroxides of type (Va) or (Vb):

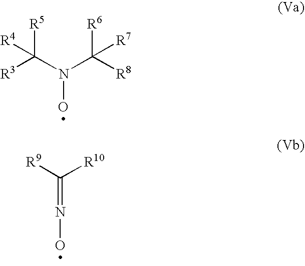

where R³, R⁴, R⁵, R⁶, R⁷, R⁸, R⁹ and R¹⁰ independently of one another denote the following compounds or atoms:
halides, such as chlorine, bromine or iodine,
linear, branched, cyclic, and heterocyclic hydrocarbons having from 1 to 20 carbon atoms, which may be saturated, unsaturated or aromatic,
esters —COOR¹¹, alkoxides —OR¹² and/or phosphonates —PO(OR¹³)₂, where R¹¹, R¹², and R¹³ stand for radicals from the second group.

Compounds (Va) or (Vb) may also be attached to polymer chains of any kind (primarily in the sense that at least one of the abovementioned radicals constitutes a polymer chain of this kind).

More preference goes to controlled regulators, for the polymerization of compounds, of the following type:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxy pyrrolidinyloxy (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxy
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide or
t-butyl t-amyl nitroxide.

U.S. Pat. No. 4,581,429 A discloses a controlled-growth radical polymerization process which uses as its initiator a compound of the formula R′R″N—O—Y, in which Y denotes a free radical species which is able to polymerize unsaturated monomers. In general, however, the reactions have low conversion rates. A particular problem is the polymerization of acrylates, which takes place only with very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific radical compounds, such as phosphorus-containing nitroxides based on imidazolidine, are used. WO 98/44008 A1 discloses specific nitroxyls based on morpholines, piperazinones and piperazinediones. DE 199 49 352 A1 describes heterocyclic alkoxyamines as regulators in controlled-growth radical polymerizations. Corresponding further developments of the alkoxyamines or of the corresponding free nitroxides improve the efficiency for the preparation of polyacrylates (Hawker, contribution to the National Meeting of The American Chemical Society, Spring 1997; Husemann, contribution to the IUPAC World Polymer Meeting 1998, Gold Coast).

As a further controlled polymerization method, atom transfer radical polymerization (ATRP) can be used advantageously to synthesize the polyacrylate PSAs, in which case use is made preferably, as initiator, of monofunctional or difunctional secondary or tertiary halides and, for abstracting the halide(s), of complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in U.S. Pat. No. 5,945,491 A, U.S. Pat. No. 5,854,364 A, and U.S. Pat. No. 5,789,487 A.

For further development, resins may be admixed to the polyacrylate PSAs. As tackifying resins for addition it is possible without exception to use any tackifier resins which are already known and are described in the literature. As representatives, mention may be made of pinene resins, indene resins, and rosins, their disproportionated, hydrogenated, polymerized, esterified derivatives and salts, the aliphatic and aromatic hydrocarbon resins, terpene resins and terpene-phenolic resins, and also C5, C9, and other hydrocarbon resins. Any desired combinations of these and other resins may be used in order to adjust the properties of the resulting adhesive in accordance with what is desired. In general it is possible to use any resin which is compatible (soluble) with the corresponding polyacrylate; in particular, reference may be made to all aliphatic, aromatic, and alkylaromatic hydrocarbon resins, hydrocarbon resins based on pure monomers, hydrogenated hydrocarbon resins, functional hydrocarbon resins, and natural resins. Express reference is made to the depiction of the state of the art in the “Handbook of Pressure Sensitive Adhesive Technology” by Donatas Satas (van Nostrand, 1989).

Furthermore, it is also possible optionally to add plasticizers, fillers (e.g., fibres, carbon black, zinc oxide, titanium dioxide, chalk, solid or hollow glass beads, microbeads made of other materials, silica, silicates), nucleators, blowing agents, compounding agents and/or ageing inhibitors, in the form for example of primary and secondary antioxidants or in the form of light stabilizers.

Additionally, crosslinkers and promoters for crosslinking may be admixed. Examples of suitable crosslinkers for UV crosslinking include difunctional or polyfunctional acrylates and methacrylates.

For crosslinking with UV light, UV-absorbing photoinitiators are advantageously added to the polyacrylate PSAs. Useful photoinitiators which are very good to use include benzoin ethers, such as benzoin methyl ether and benzoin isopropyl ether, for example, substituted acetophenones, such as 2,2-diethoxyacetophenone (available as Irgacure 651® from Ciba Geigy®), 2,2-dimethoxy-2-phenyl-1-phenylethanone, dimethoxy-hydroxyacetophenone, substituted α-ketols, such as 2-methoxy-2-hydroxypropiophenone, for example, aromatic sulphonyl chlorides, such as 2-naphthylsulphonyl chloride, for example, and photoactive oximes, such as 1-phenyl-1,2-propanedione 2-(o-ethoxycarbonyl)oxime, for example.

The abovementioned photoinitiators and others which can be used, including those of the Norrish I or Norrish II type, may contain the following radicals: benzophenone, acetophenone, benzil, benzoin, hydroxyalkylphenone, phenyl cyclohexyl ketone, anthraquinone, trimethylbenzoylphosphine oxide, methylthiophenyl morpholinyl ketone, aminoketone, azobenzoin, thioxanthone, hexaarylbisimidazole, triazine, or fluorenone, it being possible for each of these radicals additionally to be substituted by one or more halogen atoms and/or one or more alkyloxy groups and/or one or more amino groups or hydroxyl groups. A representative overview is given by Fouassier: “Photoinitiation, Photopolymerization and Photocuring: Fundamentals and Applications”, Hanser-Verlag, Munich 1995. For further details, it is possible to consult Carroy et al. in “Chemistry and Technology of UV and EB Formulation for Coatings, Inks and Paints”, Oldring (Ed.), 1994, SITA, London.

In order to produce oriented PSAs, the polymers described above are preferably coated as hotmelt systems. For the production process it may therefore be necessary to remove the solvent from the PSA. In principle it is possible here to use any of the techniques known to the skilled person. One very preferred technique is that of concentration using a single-screw or twin-screw extruder. The twin-screw extruder may be operated corotatingly or counterrotatingly. The solvent or water is distilled off preferably by way of two or more vacuum stages. Moreover, counterheating is carried out depending on the distillation temperature of the solvent. The residual solvent fractions are preferably <1%, more preferably <0.5% and very preferably <0.2%. The hotmelt is processed further from the melt.

In one preferred procedure, orientation within the PSA is produced by the coating process. For coating as a hotmelt, and hence also for orientation, it is possible to employ a variety of coating techniques. In one embodiment the polyacrylate PSAs are coated by a roll coating process, and the orientation is produced by drawing. Various roll coating techniques are described in the “Handbook of Pressure Sensitive Adhesive Technology” by Donatas Satas (van Nostrand, N.Y., 1989). In another version the orientation is achieved by coating through a melt die. A distinction can be made here between the contact process and the non-contact process. Orientation of the PSA here can be produced on the one hand within the coating die, by virtue of the die design, or else following emergence from the die, by a drawing operation. The orientation is freely adjustable. The draw ratio can be controlled, for example, by the width of the die gap. Drawing occurs whenever the layer thickness of the PSA film on the backing material to be coated is less than the width of the die gap.

In another preferred process, the orientation is achieved by extrusion coating. Extrusion coating is preferably performed using an extrusion die. The extrusion dies used may originate from one of the following three categories: T-dies, fishtail dies, and coathanger dies. The individual types differ in the design of their flow channel. Through the form of the extrusion die it is likewise possible to produce an orientation within the hotmelt PSA. Additionally, here, in analogy to melt die coating, it is likewise possible to obtain an orientation following emergence from the die, by drawing the PSA tape film.

In order to produce oriented acrylate PSAs, it is particularly preferred to carry out coating onto a backing using a coathanger die, specifically in such a way that a polymer layer is formed on the backing by means of a movement of die relative to backing.

The time which elapses between coating and crosslinking—the relaxation time, as it is called—is preferably short. In one preferred procedure, crosslinking is carried out less than 60 minutes after coating; in another preferred procedure, after less than 3 minutes. In one very preferred procedure, in an inline process, crosslinking takes place less than 5 seconds after coating.

In one preferred version, coating is carried out directly onto a backing material. Suitable backing materials include, in principle, all materials known to the skilled person, such as BOPP, PET, PVC or nonwoven, foam, or release papers (glassine, HDPE or LDPE).

The best orientation effects are obtained by deposition onto a cold surface. Therefore the backing material during coating should be cooled directly by means of a roll. The roll can be cooled by a liquid film/contact film from the outside or inside, or by a coolant gas. The coolant gas may likewise be used to cool the PSA emerging from the coating die. In one preferred version the roll is wetted with a contact medium, which is then located between the roll and the backing material. Preferred embodiments for the implementation of such a technique are described later on below. For this process it is possible to use both a melt die and an extrusion die. In one very preferred version the roll is cooled to room temperature, in an extremely preferred version to temperatures below 10° C. The roll ought to rotate during this.

In a further version of this preparation process, moreover, the roll is used for crosslinking of the oriented PSA.

UV crosslinking is effected by brief irradiation with ultraviolet radiation in a wavelength range from 200 to 400 nm, depending on the UV photoinitiator used, especially using high or medium pressure mercury lamps with an output of from 80 to 240 W/cm. The irradiation intensity is adapted to the respective quantum yield of the UV photoinitiator, the degree of crosslinking to be brought about, and for setting the extent of the orientation.

A further option is to crosslink the polyacrylate PSA additionally with electron beams. Typical irradiation equipment which may be used includes linear cathode systems, scanner systems, and segmented cathode systems, where electron beam accelerators are concerned. A detailed description of the state of the art, and the most important process parameters, can be found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably between 80 kV and 300 kV. The scatter doses employed range between 5 to 150 kGy, in particular between 20 and 100 kGy.

In a further preferred preparation process, the oriented PSA is coated onto a roll provided with a contact medium. As a result of the contact medium it is possible in turn to carry out very rapid cooling of the PSA.

As the contact medium a material can also be used which has the capacity to bring about contact between the PSA and the surface of the roll, especially a material which fills the cavities between backing material and roll surface (for example, unevennesses in the roll surface, bubbles). In order to implement this technology, a rotating chill roll is coated with a contact medium. In one preferred version the contact medium chosen is a liquid, such as water, for example. Examples of appropriate additives to water as the contact medium include alkyl alcohols such as ethanol, propanol, butanol, and hexanol, without wishing to be restricted in the selection of the alcohols as a result of these examples. Also especially advantageous are longer-chain alcohols, polyglycols, ketones, amines, carboxylates, sulphonates, and the like. Many of these compounds lower the surface tension or raise the conductivity.

A lowering in the surface tension may also be achieved by adding small amounts of nonionic and/or anionic and/or cationic surfactants to the contact medium. The most simple way of achieving this is by using commercial washing compositions or soap solutions, preferably in a concentration of a few g/l in water as the contact medium. Particularly suitable compounds are special surfactants which can be used even at low concentrations. Examples thereof include sulphonium surfactants (e.g., β-di-(hydroxyalkyl)sulphonium salt), and also, for example, ethoxylated nonylphenylsulphonic acid ammonium salts or block copolymers, especially diblocks. Here, reference may be made in particular to the state of the art under “surfactants” in Ullmann's Encyclopedia of Industrial Chemistry, Sixth Edition, 2000 Electronic Release, Wiley-VCH, Weinheim 2000.

As contact media it is possible to use the abovementioned liquids, even without the addition of water, in each case alone or in combination with one another. In order to improve the properties of the contact medium (for example, for increasing the shearing resistance, reducing the transfer of surfactants or the like to the surface of the liner, and thus improved cleaning possibilities of the end product), salts, gels, and similar viscosity-increasing additives may also be added with advantage to the contact medium and/or to the adjuvants used.

Moreover, the roll can be macroscopically smooth or may have a surface with a low level of structuring. It has been found appropriate for the roll to possess a surface structure, especially a surface roughening. This allows wetting by the contact medium to be improved.

The process proceeds to particularly good effect if the roll is temperature-controllable, preferably in a range from −30° C. to 200° C., with very particular preference from 5° C. to 25° C. The contact medium is preferably applied to the roll, although it is also possible to carry out contactless application, by spraying, for example.

In order to prevent corrosion, the roll is commonly coated with a protective coat. This coat is preferably selected so that it is wetted effectively by the contact medium. In general, the surface is conductive. It may also be more favourable, however, to coat it with one or more coats of insulating or semiconducting material.

Where a liquid is used as the contact medium, one outstanding procedure is to run a second roll, advantageously having a wettable or absorbent surface, through a bath containing the contact medium, said roll then becoming wetted by or impregnated with the contact medium and applying a film of this contact medium by contact with the roll.

The oriented PSA on the chill roll provided with the contact medium is crosslinked preferably immediately, then is transferred onto the backing material.

The characterization of the orientation within the acrylate PSAs is dependent on the coating process. The orientation can be controlled, for example, by the die temperature and coating temperature and also by the molecular weight of the polyacrylate PSA.

The degree of orientation is freely adjustable through the die gap width. The thicker the PSA film expressed from the coating die, the greater the extent to which the adhesive can be drawn to a relatively thin PSA film on the backing material. This drawing operation may be freely adjusted not only by the freely adjustable die width but also by the web speed of the decreasing backing material.

The intensity of UV irradiation, moreover, likewise serves as an adjusting parameter for the degree of orientation. By raising the UV dose it is possible to reduce the degree of orientation. The intensity of irradiation therefore serves to vary the degree of crosslinking, to vary the technical adhesive properties, and to control the anisotropy.

The orientation of the adhesive can be measured with a polarimeter, by infrared dichroism, or using X-ray scattering. It is known that the orientation in acrylate PSAs in the uncrosslinked state is retained only for a few days. During rest or storage, the system relaxes and loses its preferential direction. As a result of crosslinking after coating, this effect can be suppressed significantly. The relaxation of the oriented polymer chains converges towards zero, and the oriented PSAs can be stored for a very long period of time without loss of their preferential direction.

In addition to measuring the orientation by determining the Δn (see Test B), the measurement of the shrinkback in the free film (see Test D) is likewise suitable for determining the orientation and the anisotropic properties of the PSA.

In addition to the processes described, the orientation may also be produced following coating. In that case, then, a stretchable backing material is preferably employed, with the PSA being drawn at the same time as stretching. In this case it is also possible to use acrylate PSAs coated conventionally from solution or from water. In one preferred version, then, this drawn PSA is in turn crosslinked with UV radiation.

The invention further provides for the use of such oriented pressure-sensitive adhesives for single-sidedly or double-sidedly coated PSA tapes.

The process of the invention is described below in embodiment examples.

### EMBODIMENT EXAMPLES

### Test Methods

The following test methods have been employed in order to evaluate the technical adhesive properties of the PSAs prepared.

### 180° Bond Strength Test (Test A)

A strip, 20 mm wide, of an acrylate pressure-sensitive adhesive coated on a polyester or siliconized release paper was applied to steel plates. Depending on direction and drawing, longitudinal or transverse specimens were bonded to the steel plate. The PSA strip was pressed onto the substrate twice using a 2 kg weight. The adhesive tape was then immediately peeled from the substrate at an angle of 180° and at 30 mm/min. The steel plates were washed twice with acetone and once with isopropanol. The results were reported in N/cm and were averaged from three measurements. All measurements were conducted at room temperature under controlled-climate conditions.

### Measurement of the Birefringence (Test B)

### Version 1

Two crossed polaroid filters were placed in the sample beam of a Uvikon 910 spectrophotometer. Oriented acrylates were fixed between two slides. The path length of the oriented sample was determined from preliminary experiments by means of thickness gauges. The sample thus prepared was placed in the measuring beam of the spectrophotometer with its direction of orientation deviating in each case by 45° from the optical axes of the two polaroid filters. The transmission, T, was then monitored over time by means of a time-resolved measurement. The transmission data were then used to determine the birefringence in accordance with the following relationship:

T=sin²(π×R),

in which R is the retardation and T is the transmission, defined as T=Iₜ/I₀.

With the retardation R according to the following equation

R=d/λΔn,

in which d is the sample thickness, this ultimately provides, for the birefringence Δn:

$$Δ n = \frac{λ}{π d} arc sin \sqrt{T}$$

with:
I=intensity
T=transmission
λ=wavelength
Δn=birefringence
R=retardation.

### Version 2

The birefringence was measured with an experimental setup such as is described analogously in the Encyclopedia of Polymer Science, John Wiley & Sons, vol. 10, p. 505, 1987 as a circular polariscope. The light emitted by a diode-pumped solid-state laser of wavelength λ=532 nm was first of all linearly polarized by a polarization filter and then circularly polarized using a λ/4 plate with λ=532 nm. The laser beam thus polarized was then passed through the oriented acrylate composition. Since acrylate compositions are highly transparent, the laser beam is able to pass through the composition virtually unhindered. Where the polymer molecules of the acrylate composition are oriented, this results in a change in the polarizability of the acrylate composition depending on observation angle (birefringence). As a result of this effect, the E vector of the circularly polarized laser beam undergoes a rotation about the axis of progression of the laser beam. After departing the sample, the laser beam thus manipulated was passed through a second λ/4 plate with λ=532 nm whose optical axis deviates by 90° from the optical axis of the first λ/4 plate. This filter was followed by a second polarization filter whose plane of polarization was likewise rotated by 90° from that of the first polarization filter. Finally, the intensity of the laser beam was measured using a photosensor, and Δn was determined as described under Version 1.

### Determination of the Gel Fraction (Test C)

After careful drying, the solvent-free adhesive samples were welded into a pouch made of polyethylene nonwoven (Tyvek web). The gel index was determined from the difference in the sample weights before and after extraction with toluene.

### Measurement of the Shrinkback (Test D)

Strips with a width of at least 30 mm and a length of 20 cm were cut parallel to the coating direction of the hotmelt. At coatweights of 50 g/m², 8 strips were laminated to one another, in order to give comparable layer thicknesses. The specimen obtained in this way was then cut to a width of exactly 20 mm and at each end was overstuck with paper strips, with a spacing of 15 cm. The test specimen thus prepared was then suspended vertically at room temperature and the change in length was monitored over time until no further shrinkage of the sample could be found. The initial length reduced by the final value was then reported, relative to the initial length, as the shrinkback, in percent.

For measuring the orientation after a longer time, the coated and oriented pressure sensitive adhesives were stored in the form of swatches for a prolonged period and then analysed.

### Gel Permeation Chromatography GPC (Test E)

The average molecular weight M_{w} and the polydispersity PD were determined by gel permeation chromatography. The eluent used was THF containing 0.1% by volume trifluoroacetic acid. Measurement was made at 25° C. The precolumn used was PSS-SDV, 5μ, 10³ Å, ID 8.0 mm×50 mm. Separation was carried out using the columns PSS-SDV, 5μ, 10³ and also 10⁵ and 10⁶ Å each with ID 8.0 mm×300 mm. The sample concentration was 4 g/l, the flow rate 1.0 ml per minute. Measurement was made against PMMA standards.

### Preparation of the Samples

The preparation processes described below differ essentially in the solvent mixtures used. The polymerization was carried out in particular in a mixture of acetone and isopropanol, with an isopropanol fraction increasing from Example 1 to Example 4.

### Example 1

A 10 L reactor conventional for radical polymerizations was charged with 60 g of acrylic acid, 1800 g of 2-ethylhexyl acrylate, 20 g of maleic anhydride, 120 g of N-isopropylacrylamide and 666 g of acetone/isopropanol (98/2). After nitrogen gas had been passed through for 45 minutes with stirring, the reactor was heated to 58° C. and 0.6 g of 2,2′-azoisobutyronitrile (AIBN) in solution in 20 g of acetone was added. The external heating bath was then heated to 70° C. and the reaction was carried out constantly at this external temperature. After a reaction time of 45 minutes, 0.2 g of Vazo 52® from DuPont in solution in 10 g of acetone was added. After a reaction time of 70 minutes, a further 0.2 g of Vazo 52® from DuPont in solution in 10 g of acetone was added, and after a reaction time of 85 minutes 0.4 g of Vazo 52® from DuPont in solution in 400 g of acetone/isopropanol (98/2). After 1:45 h, 400 g of acetone/isopropanol (98/2) were added. After 2 h, 1.2 g of 2,2′-azoisobutyronitrile (AIBN) in solution in 20 g of acetone were added. After 5, 6, and 7 h, in each case 2 g of dicyclohexyl dioxypercarbonate (Perkadox 16® from Akzo Nobel) in solution in each case in 20 g of acetone were added. After a reaction time of 7 h, the mixture was diluted with 600 g of acetone/isopropanol (98/2). After a reaction time of 24 h, the reaction was terminated by cooling to room temperature. After cooling, 10 g of isopropylthioxanthone (Speedcure ITX® from Rahn) were added and completely dissolved.

### Example 2

A 10 L reactor conventional for radical polymerizations was charged with 60 g of acrylic acid, 1800 g of 2-ethylhexyl acrylate, 20 g of maleic anhydride, 120 g of N-isopropylacrylamide and 666 g of acetone/isopropanol (97/3). After nitrogen gas had been passed through for 45 minutes with stirring, the reactor was heated to 58° C. and 0.6 g of 2,2′-azoisobutyronitrile (AIBN) in solution in 20 g of acetone was added. The external heating bath was then heated to 70° C. and the reaction was carried out constantly at this external temperature. After a reaction time of 45 minutes, 0.2 g of Vazo 52® from DuPont in solution in 10 g of acetone was added. After a reaction time of 70 minutes, a further 0.2 g of Vazo 52® from DuPont in solution in 10 g of acetone was added, and after a reaction time of 85 minutes 0.4 g of Vazo 520 from DuPont in solution in 400 g of acetone/isopropanol (97/3). After 1:45 h, 400 g of acetone/isopropanol (97/3) were added. After 2 h, 1.2 g of 2,2′-azoisobutyronitrile (AIBN) in solution in 20 g of acetone were added. After 5, 6, and 7 h, in each case 2 g of dicyclohexyl dioxypercarbonate (Perkadox 16® from Akzo Nobel) in solution in each case in 20 g of acetone were added. After a reaction time of 6 h, the mixture was diluted with 600 g of acetone/isopropanol (97/3). After a reaction time of 24 h, the reaction was terminated by cooling to room temperature. After cooling, 10 g of isopropylthioxanthone (Speedcure ITX® from Rahn) were added and completely dissolved.

### Example 3

A 10 L reactor conventional for radical polymerizations was charged with 60 g of acrylic acid, 1800 g of 2-ethylhexyl acrylate, 20 g of maleic anhydride, 120 g of N-isopropylacrylamide and 666 g of acetone/isopropanol (95/5). After nitrogen gas had been passed through for 45 minutes with stirring, the reactor was heated to 58° C. and 0.6 g of 2,2′-azoisobutyronitrile (AIBN) in solution in 20 g of acetone was added. The external heating bath was then heated to 70° C. and the reaction was carried out constantly at this external temperature. After a reaction time of 45 minutes, 0.2 g of Vazo 52® from DuPont in solution in 10 g of acetone was added. After a reaction time of 70 minutes, a further 0.2 g of Vazo 52® from DuPont in solution in 10 g of acetone was added, and after a reaction time of 85 minutes 0.4 g of Vazo 52® from DuPont in solution in 400 g of acetone/isopropanol (95/5). After 2 h, 1.2 g of 2,2′-azoisobutyronitrile (AIBN) in solution in 400 g of acetone/isopropanol (95/5) were added. After a reaction time of 4 h, the mixture was diluted with 400 g of acetone/isopropanol (95/5). After 5, 6, and 7 h, in each case 2 g of dicyclohexyl dioxypercarbonate (Perkadox 16® from Akzo Nobel) in solution in each case in 20 g of acetone were added. After a reaction time of 5:30, 7, and 8:30 h, the mixture was diluted in each case with 400 g of acetone/isopropanol (95/5). After a reaction time of 24 h, the reaction was terminated by cooling to room temperature. After cooling, 10 g of isopropylthioxanthone (Speedcure ITX® from Rahn) were added and completely dissolved.

### Example 4

A 10 L reactor conventional for radical polymerizations was charged with 60 g of acrylic acid, 1800 g of 2-ethylhexyl acrylate, 20 g of maleic anhydride, 120 g of N-isopropylacrylamide and 666 g of acetone/isopropanol (93/7). After nitrogen gas had been passed through for 45 minutes with stirring, the reactor was heated to 58° C. and 0.6 g of 2,2′-azoisobutyronitrile (AIBN) in solution in 20 g of acetone was added. The external heating bath was then heated to 70° C. and the reaction was carried out constantly at this external temperature. After a reaction time of 45 minutes, 0.2 g of Vazo 52® from DuPont in solution in 10 g of acetone was added. After a reaction time of 70 minutes, a further 0.2 g of Vazo 52® from DuPont in solution in 10 g of acetone was added, and after a reaction time of 85 minutes 0.4 g of Vazo 52® from DuPont in solution in 400 g of acetone/isopropanol (93/7). After 2 h, 1.2 g of 2,2′-azoisobutyronitrile (AIBN) in solution in 20 g of acetone were added. After 2:10 h, the mixture was diluted with 400 g of acetone/isopropanol (93/7). After 5, 6, and 7 h, in each case 2 g of dicyclohexyl dioxypercarbonate (Perkadox 16® from Akzo Nobel) in solution in each case in 20 g of acetone were added. In addition after a reaction time of 5, 7, and 8:30 h, the mixture was diluted in each case with a further 400 g of acetone/isopropanol (93/7). After a reaction time of 24 h, the reaction was terminated by cooling to room temperature. After cooling, 10 g of isopropylthioxanthone (Speedcure ITX® from Rahn) were added and completely dissolved.

### Coating

The polymers prepared according to the above examples were freed from the solvent in a vacuum drying cabinet. A vacuum of 10 torr was applied and the products slowly heated to 100° C. The hotmelt PSA was then coated using a Pröls melt die. The coating temperature was 160° C. Coating took place at 20 μm/min onto a siliconized release paper from Laufenberg. The die gap width was 200 μm. After the coating operation, the amount of pressure-sensitive adhesive on the release paper was 50 g/m². Coating was carried out with application of a pressure of 6 bar to the melt die in order that the hotmelt PSA could be pressed through the die.

### Crosslinking

UV crosslinking was carried out, unless described otherwise, at room temperature 15 minutes after coating. UV crosslinking was carried out using a UV crosslinking unit from Eltosch. The UV lamp used was a medium pressure mercury lamp with an intensity of 120 W/cm². The web speed was 20 m/min, and crosslinking was carried out with full radiation. In order to vary the UV irradiation dose, the PSA tape was irradiated with a variable number of passes. The UV dose rises linearly with the number of passes. The UV doses were determined using the Power-Puck® from Eltosch. For example, for 2 passes a UV dose of 0.8 J/cm² was measured, for 4 passes 1.6 J/cm², for 8 passes 3.1 J/cm², and for 10 passes 3.8 J/cm².

### Results

First of all the molecular weights of the acrylate PSAs polymerized in accordance with Examples 1 to 4 by free radical polymerization in different solvent mixtures were investigated by means of gel permeation chromatography in accordance with Test E. The results are summarized in Table 1.

TABLE 1
Molecular weights of the polymers by Test E

| | Mₙ [g/mol] | M_{w} [g/mol] |
|---|---|---|
| Example 1 | 112 580 | 978 010 |
| Example 2 | 98 283 | 825 310 |
| Example 3 | 75 058 | 626 060 |
| Example 4 | 64 245 | 559 412 |

After the polymerization, the acrylate PSAs of Examples 1-4 were—as described in the section ‘Coating’—freed from the solvent and processed from the melt. Coating was carried out through a melt die at 160° C., onto a release paper which was left at room temperature. All the adhesives were hotmelt-processable in terms of temperature stability and flow viscosity. After 15 minutes, UV crosslinking was carried out with different doses. In order to determine the anisotropic properties (orientation), first of all the shrinkback in the free film was measured in accordance with Test D. To determine the degree of crosslinking, Test C was conducted, and hence the gel fraction was determined. The gel fraction indicates the percentage amount of the crosslinked polymer. The results are summarized in Table 2.

TABLE 2

| | Number of UV | Shrinkback in % by | Gel index in % by |
|---|---|---|---|
| | passes | Test D | Test C |
| Example 1 | 2 | 57 | 32 |
| | 3 | 50 | 50 |
| | 4 | 44 | 60 |
| | 5 | 37 | 64 |
| | 6 | 33 | 68 |
| | 8 | 27 | 73 |
| Example 2 | 2 | 52 | 29 |
| | 3 | 44 | 48 |
| | 4 | 38 | 52 |
| | 5 | 33 | 64 |
| | 6 | 30 | 70 |
| | 8 | 26 | 75 |
| Example 3 | 2 | 41 | 15 |
| | 3 | 34 | 25 |
| | 4 | 30 | 38 |
| | 5 | 21 | 47 |
| | 6 | 19 | 56 |
| | 8 | 15 | 60 |
| Example 4 | 2 | 26 | 10 |
| | 3 | 25 | 23 |
| | 4 | 10 | 37 |
| | 5 | 5 | 49 |

Table 2 indicates that a large number of oriented PSAs can be prepared by the inventive process. The degree of orientation may be very different. Thus it is possible to prepare polyacrylates having a shrinkback of 5% or having a shrinkback of 57%. Moreover, Examples 1 to 4 demonstrate that by means of the UV dose applied it is possible to control the shrinkback and hence also the orientation. From the figures it can be inferred that the shrinkback decreases when the UV dose is raised, and at the same time there is an increase in the gel index. This in turn influences the technical adhesive properties, so that by means of the UV dose applied it is possible to control not only the technical adhesive properties but also the extent of orientation.

In order to confirm the influence of degree of crosslinking on the technical adhesive properties, the bond strengths were measured in accordance with Test A. The results are listed in Table 3.

TABLE 3

| | Number of UV | BS [N/cm] by | Gel index [%] by |
|---|---|---|---|
| | passes | Test A | Test C |
| Example 1 | 2 | 4.2 | 32 |
| | 3 | 3.9 | 50 |
| | 4 | 3.7 | 60 |
| | 5 | 3.5 | 64 |
| | 8 | 3.2 | 73 |
| Example 2 | 2 | 4.3 | 29 |
| | 3 | 3.8 | 48 |
| | 5 | 3.5 | 64 |
| | 8 | 3.3 | 75 |
| Example 3 | 2 | 4.2 | 15 |
| | 3 | 3.9 | 25 |
| | 4 | 3.6 | 38 |
| | 6 | 3.3 | 56 |
| | 8 | 3.2 | 60 |
| Example 4 | 2 | 4.1 | 10 |
| | 3 | 3.5 | 23 |
| | 4 | 3.4 | 37 |
| | 5 | 3.2 | 49 |

BS = instantaneous bond strength on steel

For use as an oriented PSA, the retention of the orientation is essential. For a number of examples, therefore, the shrinkback was measured in accordance with Test D following storage for one month at room temperature. The figures are set out in Table 4.

TABLE 4

| | Number of UV | Shrinkback [%] by | Shrinkback [%] by |
|---|---|---|---|
| | passes | Test D | Test D after 30 days |
| Example 1 | 2 | 57 | 55 |
| | 3 | 50 | 48 |
| | 4 | 44 | 41 |
| | 5 | 37 | 37 |
| | 6 | 33 | 30 |
| | 8 | 27 | 25 |
| Example 2 | 2 | 52 | 50 |
| | 3 | 44 | 40 |
| | 4 | 38 | 36 |
| | 5 | 33 | 32 |
| | 6 | 30 | 28 |
| | 8 | 26 | 24 |
| Example 3 | 2 | 41 | 40 |
| | 3 | 34 | 32 |
| | 4 | 30 | 27 |
| | 5 | 21 | 19 |
| | 6 | 19 | 15 |
| | 8 | 15 | 12 |
| Example 4 | 2 | 26 | 24 |
| | 3 | 25 | 20 |
| | 4 | 10 | 8 |
| | 5 | 5 | 4 |

From Table 4 it can be inferred that in some cases the shrinkback does go down, but that the percentage changes are very small. All of the examples depicted still have a shrinkback even after storage for 30 days, exhibit very little relaxation if any, and continue to possess anisotropic properties.

The orientation within the acrylate PSAs was determined, moreover, by quantifying the birefringence. The refractive index n of a medium is given by the ratio of the speed of light in a vacuum, c₀, to the speed of light in the medium in question, c (n=c₀/c), n being a function of the wavelength of the respective light. As a measure of the orientation of the pressure-sensitive adhesive, use is made of the difference Δn between the refractive index measured in a preferential direction (stretching direction, machine direction MD), n_{MD}, and the refractive index measured in a direction perpendicular to the preferential direction (cross-direction, CD), n_{CD}. In other words, Δn=n_{MD}−n_{CD}; this figure is obtainable through the measurements described in Test B.

All examples showed orientation of the polymer chains. The Δn values found are listed in Table 5.

TABLE 5

| | | Shrinkback in | |
|---|---|---|---|
| | Number of UV | [%] by | Δn values |
| | passes | Test D | Test B |
| Example 1 | 2 | 57 | 1.8 · 10⁻⁴ |
| | 3 | 50 | 8.6 · 10⁻⁵ |
| Example 2 | 4 | 38 | 6.6 · 10⁻⁵ |
| | 5 | 33 | 2.6 · 10⁻⁵ |
| Example 3 | 5 | 21 | 9.5 · 10⁻⁶ |
| | 6 | 19 | 8.7 · 10⁻⁶ |
| Example 4 | 4 | 10 | 5.1 · 10⁻⁶ |
| | 5 | 5 | 2.6 · 10⁻⁶ |

Orientation within the acrylic PSAs was therefore found for the samples measured, by the measurement of birefringence.

Taking into account the results, it is possible to realize new pressure-sensitive adhesive tape products which make use of this described effect. When adhesive bonds are made on cable harnesses in the engine compartment, the temperature differences which occur are in some cases very high. It is therefore preferred to use acrylate PSA tapes for such applications. In contrast to a customary commercial acrylate adhesive, an oriented adhesive will contract on heating, by the shrinkback measured and described, and so will form a firm bond from the cables and the insulating nonwoven. The advantages are retained in relation to the oriented natural rubber adhesives, these advantages being, for example, higher temperature stability in a large temperature window, and improved ageing stability.

The shrinkback effect may also be utilized in the case of adhesive bonds on convex surfaces. By applying a pressure-sensitive adhesive tape to a convex surface, with subsequent heating, the PSA tape contracts and so conforms to the convexity of the substrate. In this way, adhesive bonding is greatly facilitated and the number of air inclusions between substrate and tape is greatly reduced. The PSA is able to exert its optimum effect. This characteristic can be assisted further by an oriented carrier material. Following application, under heating, both the carrier material and the oriented PSA shrink, so that the bonds on the convexity are completely stress-free.

The pressure-sensitive adhesives of the invention likewise offer a wide range for applications which utilize advantages of the low stretch in the longitudinal direction and the possibility of shrinkback in an advantageous way.

The property of the pre-stretch of the pressure-sensitive adhesives can also be utilized to outstanding effect. A further exemplary field of use for such highly oriented acrylate PSAs is that of strippable double-sided adhesive bonds. Unlike conventional strippable products, the oriented PSA is already pre-stretched to several 100%, so that in order to remove the double-sided bond the acrylic PSA need only be stretched by a few percent more in the stretching direction (MD). With particular preference, these products are produced as acrylate hotmelts with a film thickness of several 100 μm. Straight acrylates are used with particular preference. As compared with conventional systems (multilayer systems, SIS adhesives), the oriented acrylate strips are transparent, stable towards ageing, and inexpensive to manufacture.

1. Permanently oriented pressure-sensitive adhesive comprising an acrylate-based UV-crosslinked polymer which 1.) is synthesized in a mass fraction of at least 50% from at least one acrylic monomer according to the general formula (I) 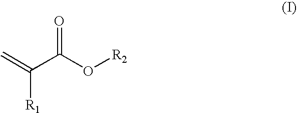
in which R₁ is hydrogen (H) or a methyl group (CH3) and R₂ is hydrogen (H) or a branched or unbranched, saturated C₁ to C₃₀ hydrocarbon radical, which may optionally be substituted by a functional group, and 2.) is composed in a mass fraction of from 0.05% to 1% of a UV-crosslinked photoinitiator, the pressure-sensitive adhesive, in the form of a film applied as a melt (hotmelt), having a preferential direction which is characterized in the free film by a shrinkback of at least 3% relative to an original stretching of the film in the preferential direction.

2. Pressure-sensitive adhesive according to claim 1, characterized by a refractive index measured in a preferential direction, n_{MD}, which is greater than a refractive index measured in a direction perpendicular to the preferential direction, n_{CD}, the difference Δn=n_{MD}−n_{CD} being at least 1·10⁻⁶.

3. Pressure-sensitive adhesive according to claim 1, characterized by an average molecular weight of the acrylate polymer of at least 200 000 g/mol.

4. Pressure-sensitive adhesive according to claim 1 characterized in that the radical R₂ of the at least one acrylic monomer according to the general formula (I) is chosen from the group of unbranched or branched, saturated C₄ to C₁₄ hydrocarbon radicals, in particular C₄ to C₉ hydrocarbon radicals.

5. Pressure-sensitive adhesive according to claim 1, characterized in that the at least one acrylic monomer according to the general formula (I) is selected from the group consisting of methyl acrylate, methyl methacrylate, ethyl acrylate, n-propyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate and behenyl acrylate and also branched isomers of these, especially isobutyl acrylate, 2-ethylhexyl acrylate, 2-ethylhexyl methacrylate, isooctyl acrylate and isooctyl methacrylate.

6. Pressure-sensitive adhesive according to claim 1, characterized in that R₂ is a bridged or unbridged, substituted or unsubstituted cycloalkyl group and in that in particular the at least one acrylic monomer of formula (I) is selected from the group consisting of cyclohexyl methacrylate, isobornyl acrylate, isobornyl methacrylate and 3,5-dimethyladamantyl acrylate.

7. Pressure-sensitive adhesive according to claim 1, characterized in that the acrylate polymer is synthesized from at least one further acrylic or vinylic comonomer.

8. Pressure-sensitive adhesive according to claim 1, characterized in that the at least one monomer of the formula (I) and/or the at least one comonomer carries a functional group selected from the group consisting of carboxyl, sulphonic acid, phosphonic acid, hydroxyl, lactam, lactone, N-substituted amide, N-substituted amine, carbamate, epoxy, thiol, alkoxy, cyano, ether or halide group.

9. Pressure-sensitive adhesive according to claim 1 characterized in that the at least one comonomer is selected from the group of the N-alkyl-substituted amides, in particular from the group consisting of N,N-dimethylacrylamide, N,N-dimethylmethacrylamide, N-tert-butylacrylamide, N-vinylpyrrolidone, N-vinyllactam, dimethylaminoethyl acrylate, dimethylaminoethyl methacrylate, diethylaminoethyl acrylate, diethylaminoethyl methacrylate, N-methylolacrylamide, N-methylolmethacrylamide, N-(butoxymethyl)methacrylamide, N-(ethoxymethyl)acrylamide and N-isopropylacrylamide.

10. Pressure-sensitive adhesive according to claim 1, characterized in that the at least one comonomer is selected from the group consisting of hydroxyethyl acrylate, hydroxyethyl methacrylate, hydroxypropyl acrylate, hydroxypropyl methacrylate, allyl alcohol, maleic anhydride, itaconic anhydride, itaconic acid, glycidyl methacrylate, phenoxyethyl acrylate, phenoxyethyl methacrylate, 2-butoxyethyl acrylate, 2-butoxyethyl methacrylate, cyanoethyl acrylate, cyanoethyl methacrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, and dimethylacrylic acid.

11. Pressure-sensitive adhesive according to claim 1, characterized in that the at least one comonomer is selected from the group consisting of vinyl esters, vinyl ethers, vinyl halides, vinylidene halides, vinyl compounds containing aromatic rings and vinyl compounds containing heterocycles in α position from the group consisting of vinyl acetate, vinylformamide, vinylpyridine, ethyl vinyl ether, vinyl chloride, vinylidene chloride and acrylonitrile.

12. Pressure-sensitive adhesive according to claim 1, characterized in that the at least one comonomer is selected from the group consisting of aromatic vinyl compounds, in particular having aromatic C₁ to C₁₈ nuclei with or without heteroatoms, especially styrene and styrene derivatives, 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate, 4-biphenylyl methacrylate, 2-naphthyl acrylate and 2-naphthyl methacrylate.

13. Pressure-sensitive adhesive according to claim 1, characterized in that the acrylate polymer is further synthesized from at least one crosslinker which is selected in particular from the group consisting of difunctional or polyfunctional acrylates and/or methacrylates, difunctional or polyfunctional isocyanates and difunctional or polyfunctional epoxides.

14. Pressure-sensitive adhesive according to claim 1, characterized in that resins and/or other additives are added to the pressure-sensitive adhesive, especially ageing inhibitors, light stabilizers, ozone protectants, fatty acids, plasticizers, nucleators, blowing agents, accelerators and/or fillers.

15. Process for preparing an oriented pressure-sensitive adhesive according to claim 1, comprising the steps of
(a) polymerizing at least one acrylic monomer according to the general formula (I), 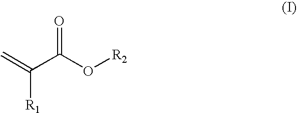
in which R₁ is hydrogen (H) or a methyl group (CH₃) and R₂ is hydrogen (H) or a branched or unbranched, saturated C₁ to C₃₀ hydrocarbon radical which is optionally substituted by a functional group,
(b) coating the acrylic polymer from the melt to form a film, in the course of which an orientation comes about in the pressure-sensitive adhesive, and
(c) crosslinking the film by means of UV radiation.

16. Process according to claim 15, characterized in that coating takes place via a roll, through a melt die or through an extrusion die.

17. Process according to claim 15, characterized in that after the coating operation the film is subjected to a drawing operation.

18. Process according to claim 15, characterized in that prior to the coating operation solvent residues from the polymerization are removed at least partly, in particular in a concentrating extruder.

19. Process according to claim 15, characterized in that the relaxation time which elapses between coating and crosslinking is as small as possible.

20. Process according to claim 19, characterized in that the relaxation time amounts to not more than 60 minutes, in particular not more than 3 minutes, preferably not more than 5 seconds.

21. Process according to claim 15, characterized in that a degree of orientation of the pressure-sensitive adhesive is controlled by the UV dose, by the coating temperature, the molecular weight of the polymer, the draw ratio and/or the relaxation time between coating and crosslinking.

22. Process according to claim 15, characterized in that cooling is carried out during coating.

23. Process according to claim 15, characterized in that the polymerization is carried out in the presence of a crosslinker which is selected in particular from the group consisting of difunctional or polyfunctional acrylates and/or methacrylates, difunctional or polyfunctional isocyanates and difunctional or polyfunctional epoxides.

24. Process according to claim 15, characterized in that for crosslinking the pressure-sensitive adhesive comprises a UV initiator.

25. Use of a pressure-sensitive adhesive according to claim 1 as a one-side or both-sides adhesive layer for a single-sided or double-sided pressure-sensitive adhesive tape.
